(19) United States
(12) Patent Application Publication
(10) Pub. No.: US 2025/0371280 A1
(43) Pub. Date: Dec. 4, 2025

(54) Anchor-Based Discourse Parsing

(71) Applicant: LegalDocumentGeneration, Inc., Santa Monica, CA (US)

(72) Inventor: Isaac Manoff, Santa Monica, CA (US)

(21) Appl. No.: 18/680,132

(22) Filed: May 31, 2024

(51) Int. Cl. G06F 40/35; G06F 16/34; G06F 40/205; G06Q 50/18

(52) U.S. Cl. CPC G06F 40/35; G06F 16/345; G06F 40/205; G06Q 50/18

(57) ABSTRACT

Anchor-based discourse parsing includes detecting a series of anchor questions in a discourse wherein each anchor question corresponds to a semantic shift in the discourse and identifying a set of semantically related discourse for each anchor question, and associating each semantically self-contained passage with a respective navigation marker that enables locating of the respective semantically self-contained passages in a transcript.

### BACKGROUND OF THE INVENTION

An event in a legal proceeding typically involves a discourse, e.g., a dialogue, discussion, interrogation, etc., among individuals. For example, a deposition in a legal proceeding typically involves a series of questions posed to and answers obtained from a party being deposed. A record of such an event can be made using audio recording, video recording, etc. Such records can be converted to text transcripts for later reference in a legal proceeding.

### SUMMARY OF THE INVENTION

In general, in one aspect, the invention relates to anchor-based parsing of a discourse into a series of semantically self-contained passages by detecting a series of anchor questions in the discourse wherein each anchor question corresponds to a semantic shift in the discourse, and by identifying a set of semantically related discourse for each anchor question, and by associating each semantically self-contained passage with a respective navigation marker that enables locating of the respective semantically self-contained passages in the transcript.

Other aspects of the invention will be apparent from the following description and the appended claims.

### BRIEF DESCRIPTION OF DRAWINGS

Embodiments of the present invention are illustrated by way of example, and not by way of limitation, in the figures of the accompanying drawings and in which like reference numerals refer to similar elements.

FIG. 1 illustrates anchor-based discourse parsing in one or more embodiments in which an anchor-based discourse parser parses a discourse contained in a transcript.

FIG. 2 shows an example transcript of an interrogation of a murder suspect.

FIG. 3 illustrates a parsed document constructed by an anchor-based discourse parser in response to the transcript shown in FIG. 2.

FIG. 4 illustrates an embodiment of an anchor-based discourse parser that includes a neural network trained for identifying anchor questions.

FIG. 5 illustrates an anchor-based discourse parser that functions as a preprocessing pipeline for a document summarizer.

FIG. 6 illustrates a method for resolving ambiguities in identified anchor questions in one or more embodiments.

FIG. 7 depicts a merger of a pair adjacent semantically self-contained passages in one or more embodiments.

FIG. 8 illustrates a computing system upon which one or more of the functions of the present teachings can be implemented.

### DETAILED DESCRIPTION OF THE INVENTION

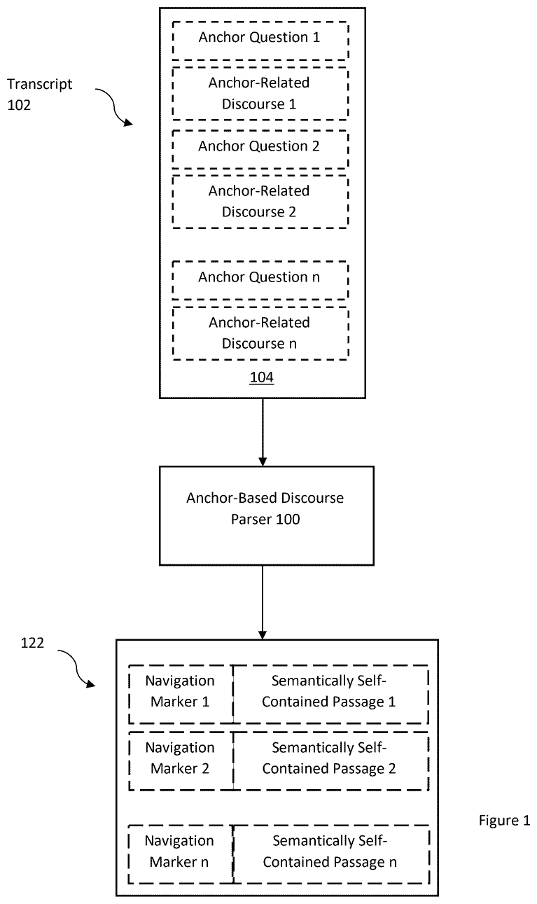

FIG. 1 illustrates anchor-based discourse parsing in one or more embodiments in which an anchor-based discourse parser 100 parses a discourse 104 contained in a transcript 102. The discourse 104 in the transcript 102 can be of a deposition in a legal proceeding, a trial transcript, a police interrogation transcript, an interrogatory, dialogues of various kinds, e.g., conversations, monologues, and speeches, etc., made in lectures, symposiums, brainstorms, online or other recorded conversations, etc., to name just a few examples.

The anchor-based discourse parser 100 parses the discourse 104 into a series of semantically self-contained passages 1-n. The anchor-based discourse parser 100 identifies the semantically self-contained passages 1-n by detecting a series of anchor questions 1-n in the discourse 104. Each anchor question 1-n is a question that includes a set of information within the question that enables the question to be understood independently of the remainder of the discourse 104.

The anchor-based discourse parser 100 further identifies a respective set of anchor-related discourse 1-n for each identified anchor question 1-n. Examples of anchor-related discourse include answers to anchor questions and follow-up questions to anchor questions.

The anchor question 1 along with the anchor-related discourse 1 taken together read as the semantically self-contained passage 1. Likewise, the anchor question 2 and the anchor-related discourse 2 taken together read as the semantically self-contained passage 2, and so on.

The anchor-based discourse parser 100 packages the anchor questions 1-n and corresponding anchor-related discourses 1-n into a parsed document 122 as the semantically self-contained passages 1-n and associates each packaged semantically self-contained passage 1-n with a respective navigation marker 1-n that enables locating of the respective semantically self-contained passages 1-n in the transcript 102. In one or more embodiments, the navigation markers 1-n are derived from a set of page and line numbers of the transcript 102.

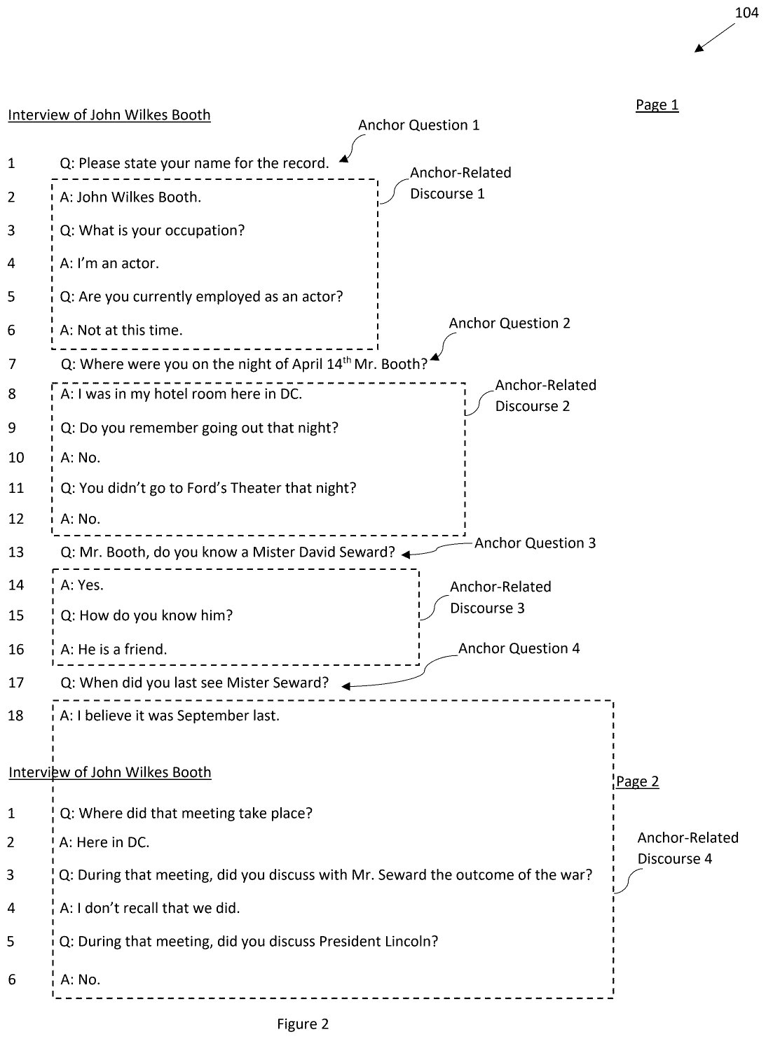

FIG. 2 shows an example in which the transcript 102 is of an interrogation of a murder suspect. The transcript 102 includes pages 1 and 2 markers along with respective line number markers, lines 1-18 on page 1 and lines 1-6 on page 2.

The anchor-based discourse parser 100 identifies the anchor question 1 on page 1, line 1. The question on page 1, line 1 is an anchor question because “Please state your name for the record” can be understood without reference to any of the other discourse in the interrogation. The anchor-based discourse parser 100 identifies the discourse on page 1, lines 2-6 as the anchor-related discourse 1 because the questions and answers on page 1, lines 2-6 depend on other discourse in the interrogation to be fully understood.

The anchor-based discourse parser 100 identifies the anchor question 2 on page 1, line 7. The question on page 1, line 7 is an anchor question because “Where were you on the night of April 14th Mr. Booth?” can be understood without reference to any of the other discourse in the interrogation. The anchor-based discourse parser 100 identifies the discourse on page 1, lines 8-12 as the anchor-related discourse 2 because the questions and answers on page 1, lines 8-12 depend on “Where were you on the night of April 14th Mr. Booth?” to be fully understood.

Likewise, the anchor-based discourse parser 100 identifies the anchor questions 3 and 4 on page 1 line 13 and page 1, line 17, respectively, and identifies the anchor-related discourses 3 and 4 on page 1, lines 14-16 and page 1, line 18 through page 2, line 6, respectively.

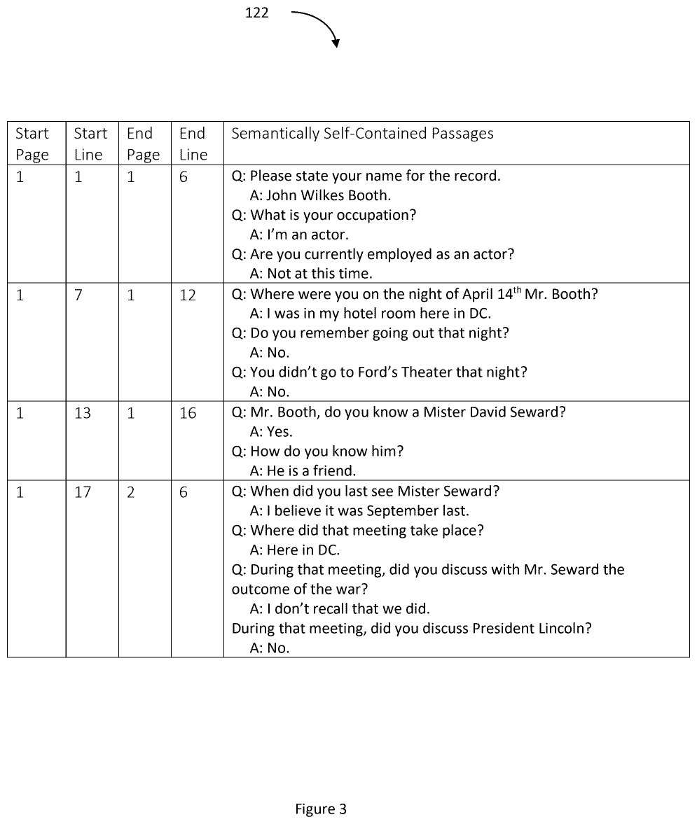

FIG. 3 illustrates the parsed document 122 constructed by the anchor-based discourse parser 100 in response to the transcript 102 shown in FIG. 2. The navigation markers 130, Start Page, Start Line, End Page, End Line, are derived the page and line numbers in the transcript 102 shown in FIG. 2.

The anchor questions 1-n are identified in one or more embodiments by differentiating between questions in the discourse 104 that present enough information within the question to be understood independently of the remainder of the discourse 104 and follow-up questions which do not. An anchor question often introduces a new topic or corresponds to a substantial point within, e.g., a testimony, thereby serving as a reference point for subsequent discourse.

Examples of anchor questions include the following:
“Could you please state your full name and current address for the record?”
“What was your position at the company in December 2013?”
“Can you describe the events that occurred on the evening of July 15th?”
“How do you know the defendant in this case?”
“What is your understanding of the contract terms discussed in Exhibit A?”
“On what basis did you form your opinion that the product was defective?”
“What safety procedures were in place at the worksite in 2020?”

In contrast, follow-up questions depend on prior dialogue for full comprehension. Follow up questions often delving deeper into topics raised by anchor questions or seek further clarification. Follow up questions are not contextually self-sufficient and are thus grouped with the relevant anchor question to maintain the coherence of a discourse. Follow up questions can be recognized by the use of ambiguous referents or incomplete information. Examples of follow-up questions include:
“What did you do then?”
“Did you discuss these terms with anyone else?”
“Who did you see there?”
“What is his profession?”
“At what point did it stop?”
“When was that?”

Follow up questions carry context from previous discourse and are placed after respective anchor questions thereby providing a proper semantic context for a story unfolding in the discourse 104.

An anchor question can be identified based on the presence of particular parts of speech including but not limited to the following:

Whether a question mark ‘?’ is present. This is a basic requirement for a question.

Whether a proper noun is present, e.g., a noun that is a specific name of a particular person, place, or thing. This can identify questions that involve specific entities.

Whether a proper noun subject is present, e.g., tokens that are either the subject or passive subject and are proper nouns or the words “you,” “I,” or “I'm” in lowercase. This aims to identify questions with specific subjects.

Whether a question ends with a verb or specific words, e.g., “this,” “that,” “these,” “those,” or “it”. This can identify questions that need additional context to be meaningful.

Whether a demonstrative pronoun is present, e.g., “this,” “that,” “these,” “those,” “them,” or “it”, indicating proximity or reference to something specific.

Whether a question starts with a case-insensitive “and” indicating a question that are part of a larger context.

The presence of the case-insensitive word “exhibit” indicating a question related to the introduction of exhibits in a legal setting.

The parts of speech set forth above indicate that a question is well formed and makes sense without additional context. For example, the following question would be considered an anchor question: “Q: John, where were you on night of Dec. 12, 2022?” This question contains sufficient context and information to be deemed an anchor question.

On the other hand, the following question will not be considered an anchor question: “Q: And what did you do that night?” The question is not meaningful without additional context. Therefore, the semantics-based discourse summarizer 100 groups the question the with preceding dialogue until an anchor question is identified.

Another example of phrase from an examining attorney not considered an anchor question is “Q: What did . . . ” when the examining attorney has been interrupted by another speaker in e.g., a deposition, making the question nonsensical. Such a phrase question is grouped with previous dialogue to provide additional context.

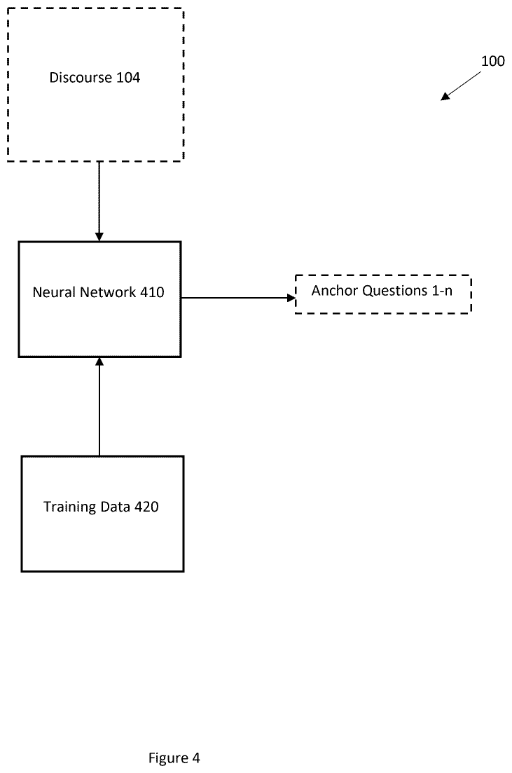

FIG. 4 illustrates an embodiment of the anchor-based discourse parser 100 that includes a neural network 410 trained for identifying the anchor questions 1-n in the discourse 104. In one or more embodiments, the anchor-based discourse parser 100 tokenizes each question in the discourse 104 and passes the tokenized version into the neural network 410 which has been trained to identify anchor questions, i.e., cognizable questions that make sense without additional context. For example, the neural network 410 in one or more embodiments is trained on a large number of deposition transcripts which provides a set of training data 420.

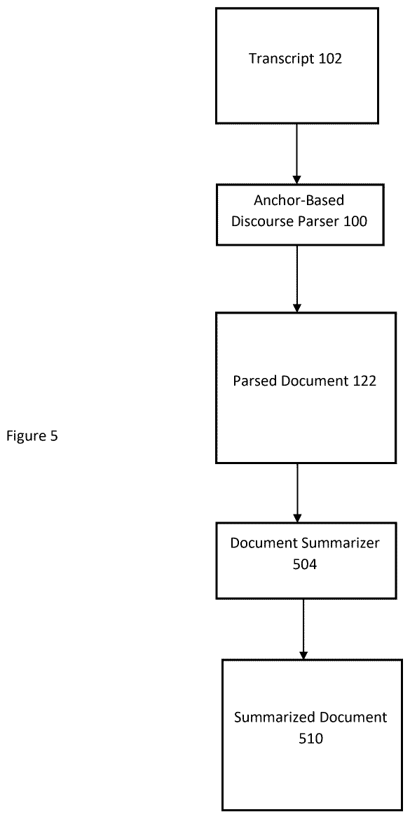

FIG. 5 illustrates how, in one or more embodiments, the anchor-based discourse parser 100 functions as a preprocessing pipeline for a document summarizer 504 that generates a summarized document 510 in response to the parsed document 122. The document summarizer 504 can use any number of methods to generate the summarized document 510 in response to the semantically self-contained passages 1-n in the parsed document 122.

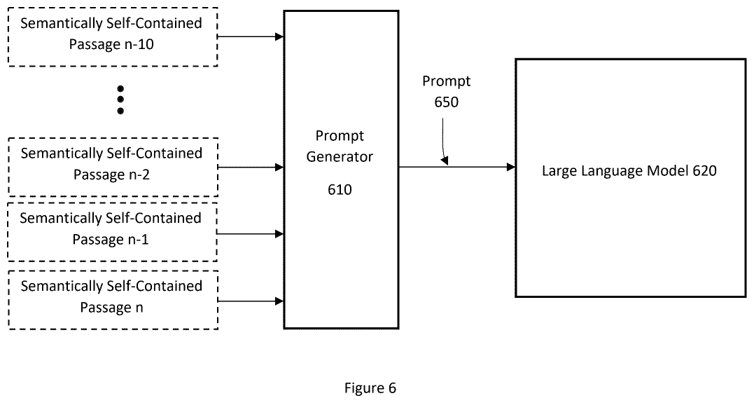

FIG. 6 illustrates a method for resolving ambiguities in any of the anchor question 1-n in one or more embodiments. In this example, a prompt generator 610 generates a prompt 650 asking a large language model 620 to resolve an ambiguity in the anchor question n based on the previous 10 semantically self-contained passages n-1 through n-10.

Ambiguity resolution is a process of correcting errors in anchor detection. In the following example, the semantically self-contained passage 1 is as follows:
Q When were you hired by InfoWars?
A I was hired in 2004 by Alex Jones.
Q Do you know what corporate entity you were hired by?
A At the time I felt I was hired by Alex Jones, and he was an independent proprietor.
MR. ENOCH: Objection, nonresponsive.
Q (BY MR. BANKSTON) Do you know today what entity your former employer claims you worked for?
A Yes.
Q What entity is that?
A Free Speech Systems, LLC.

And the semantically self-contained passage 1 is as follows:
Q Okay. When did your employment end?—our system has identified this question an anchor question, even though it is still somewhat vague as the question is really asking “when did your employment with infowars)
A My employment ended on May 1st of 2017—or April 30th.
Q So am I right that that's over a decade that you were at InfoWars?
A I was there for around 13 years, approximately.

An example of an ambiguity resolution prompt applied to each anchor question with the N previous question/answer pairs is as follows:

Please review the following Q/A transcript excerpt from the deposition of $deponent_name and follow these instructions:

### Instructions (do not Repeat in Your Response):

In the final question (Q), identify pronouns and ambiguous entities.

Look through the transcript for references to the ambiguities you found in step 1. Add the references using parenthesis to the Final Question.

Make sure that any references you add use information verbatim from the rest of the transcript and add nothing new. If not, then remove it.

Surround any references you make with parenthesis.

DO NOT attempt to answer the last Q. Your response should just rewrite the question per the instructions above and should always begin with Q.

### Transcript:

Q When were you hired by InfoWars?
A I was hired in 2004 by Alex Jones.
Q Do you know what corporate entity you were hired by?
A At the time I felt I was hired by Alex Jones, and he was an independent proprietor.
MR. ENOCH: Objection, nonresponsive.
Q (BY MR. BANKSTON) Do you know today what entity your former employer claims you worked for?
A Yes.
Q What entity is that?
A Free Speech Systems, LLC.

### Final Question:

Q Okay. When did your employment end?

Remember, do not repeat the instructions. Do include language like ‘ambiguous entities’ in your response. You should only rewrite the Final Q with the clarifications to the ambiguities in parentheses and nothing else.

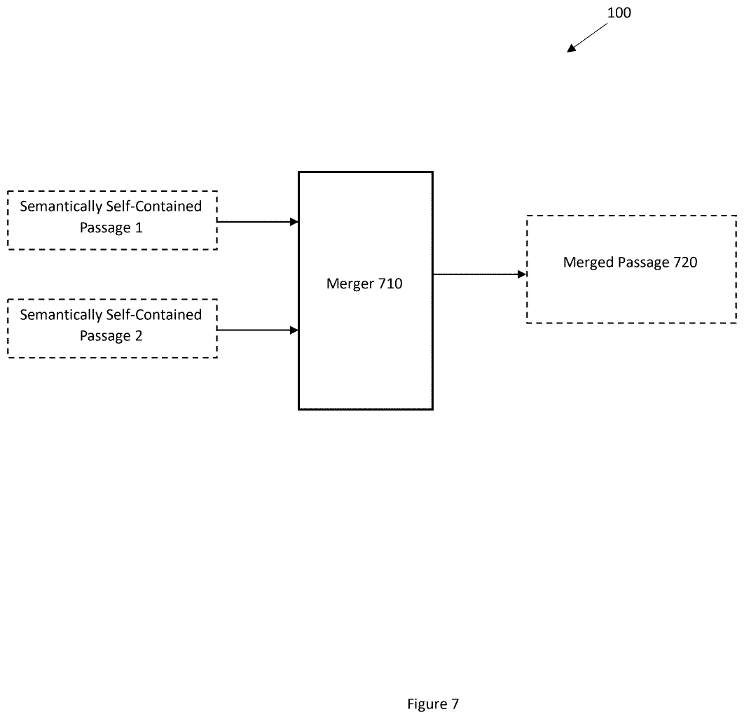

FIG. 7 shows how the anchor-based discourse parser 100 performs a merger 710 of the adjacent semantically self-contained passages 1 and 2 in one or more embodiments. The merger 710 combines the adjacent semantically self-contained passages 1 and 2 based on semantic similarity. The merger 710 in one or more embodiments precedes any ambiguity resolution step and is governed by a calibrated similarity threshold. The threshold level in one or more embodiments is adjustable so that a lower threshold results in broader citations through the merging of more dialogue, while a higher threshold maintains narrow citations by merging fewer passages.

The merger 710 in one or more embodiments employs advanced computational techniques such as cosine similarity, Jaccard coefficients, and sentence embeddings to measure the semantic similarity between passages. By setting the appropriate threshold, the anchor-based discourse parser 100 selectively integrates passages with a high degree of contextual and thematic alignment, thus ensuring an appropriate balance between breadth and precision in the citations.

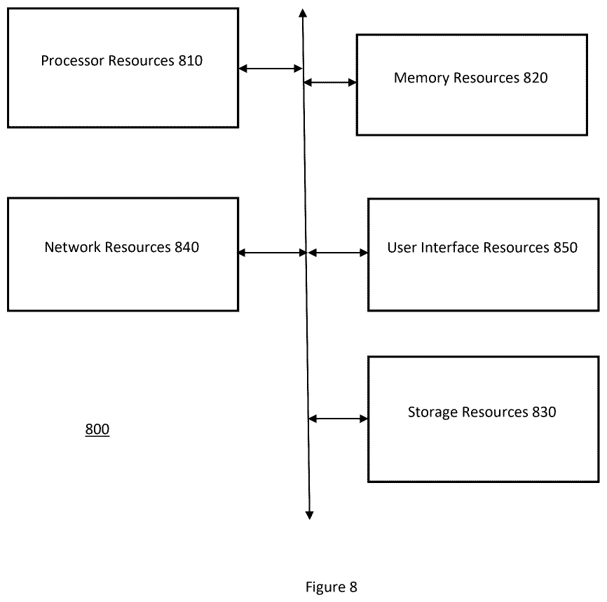

FIG. 8 illustrates a computing system 800 upon which one or more of the functions of the present teachings can be implemented. The computing system 800 includes a set of processor resources 810, a set of memory resources 820, a set of network resources 840, a set of user interface resources 850, and a set of storage resources 830. The computing system 800 in one or more embodiments executes code for performing one or more of the functions of the anchor-based discourse parser 100, e.g., performing a semantics-based parsing of a transcript as illustrated above. In some embodiments, the computing system 800 trains a neural network for recognizing anchor questions in a discourse. The computing system 800 can have a variety of implementations, e.g., personal computers, data centers, etc.

1. A method for anchor-based discourse parsing, comprising: parsing a transcript of a discourse into a series of semantically self-contained passages by detecting a series of anchor questions in the discourse, each anchor question corresponding to a semantic shift in the discourse, and identifying a set of semantically related discourse for each anchor question, and associating each semantically self-contained passage with a respective navigation marker that enables locating of the respective semantically self-contained passages in the transcript.

2. The method of claim 1, wherein detecting includes detecting a question in the discourse that includes a set of information within the question that enables the question to be understood independently of the remainder of the discourse.

3. The method of claim 1, wherein identifying comprises identifying a question in the discourse that cannot be understood independently of the remainder of the discourse.

4. The method of claim 1, wherein identifying comprises identifying an answer in the discourse that cannot be understood independently of the remainder of the discourse.

5. The method of claim 1, wherein detecting includes training a neural network to detect the anchor questions.

6. The method of claim 1, wherein the navigation markers are derived from a set of page and line numbers of the transcript.

7. The method of claim 1, wherein the transcript is of a deposition in a legal proceeding.

8. The method of claim 1, further comprising resolving an ambiguity in at least one of the anchor questions using a large language model.

9. The method of claim 1, further comprising merging at least two of the semantically self-contained passages by determining a similarity metric in response to the two.
